(19) United States
(12) Patent Application Publication
(10) Pub. No.: US 2016/0201360 A1
(43) Pub. Date: Jul. 14, 2016

(54) COMPONENT OF A MOTOR VEHICLE DOOR LOCK ARRANGEMENT

(71) Applicant: Brose Schliesssysteme GmbH & Co. KG, Wuppertal (DE)

(72) Inventors: David Rosales, Rochester Hills, MI (US); Michael Wittelsbuerger, Lake Orion, MI (US); Stepan Hanke, Lake Orion, MI (US)

(21) Appl. No.: 14/994,548

(22) Filed: Jan. 13, 2016

Related U.S. Application Data
(60) Provisional application No. 62/102,952, filed on Jan. 13, 2015.

(51) Int. Cl. E05B 79/20; E05C 3/16; E05B 79/22; E05C 3/12

(52) U.S. Cl. CPC E05B 79/20; E05C 3/124; E05C 3/16; E05B 79/22

(57) ABSTRACT

The invention is directed to a component of a motor vehicle door lock arrangement, wherein the component comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement. It is proposed that a support spring arrangement with its spring bias may act laterally with respect to the longitudinal extension of the inner cable arrangement onto the first end section of the inner cable arrangement to counteract a lateral deviation from a predefined placement of the first end section.

### PRIORITY CLAIM

This application claims the benefit of U.S. Provisional Application No. 62/102,952, filed Jan. 13, 2015, the content of which is herein incorporated by reference in its entirety.

### FIELD OF THE TECHNOLOGY

The invention is directed to a component of a motor vehicle door lock arrangement.

### BACKGROUND

The component in question is assigned to a motor vehicle door lock arrangement, which comprises a motor vehicle door lock. Such a motor vehicle door lock is assigned to a motor vehicle door arrangement which comprises at least a motor vehicle door. The expression “motor vehicle door” is to be understood in a broad sense. It includes in particular side doors, back doors, lift gates, trunk lids or engine hoods. Such a motor vehicle door may generally be designed as a sliding door as well.

The motor vehicle door lock arrangement may consist of a number of components. Besides the motor vehicle door lock such components are an inner door handle or an outer door handle, an auxiliary closing drive for moving the motor vehicle door from a preliminary closed position into a fully closed position or the like.

The known component (DE 20 2006 007 694 U1), which is the starting point of the invention, is an outer door handle of the motor vehicle door lock arrangement, which moveable handle bar may be coupled to a bowden cable for providing a drive connection between the door handle and a motor vehicle door lock. The bowden cable is of usual structure and comprises an inner cable arrangement, which is guided in an outer conduit arrangement. The inner cable arrangement comprises a cable strand and at a first end section of the inner cable arrangement a barrel shaped engagement element. The engagement element is in form fit engagement with the handle bar via a coupling arrangement.

One challenge with the known component is to secure the barrel shaped engagement element in form fit engagement with the handle bar. This is in particular because of the vibrations and shocks occurring during the drive operation of the motor vehicle. Besides the risk of the engagement element coming out of coupling engagement from the handle bar, the above noted vibrations may lead to an undesirable rattling noise due to a certain play between the barrel shaped engagement element and the coupling arrangement. The latter aspect may be improved by introducing grease material into the coupling arrangement, which is costly and time consuming during manufacture.

Furthermore the known component runs the risk of the generation of buckling of the cable strand of the inner cable arrangement. This may be caused by a blockage of the barrel shaped engagement element in the coupling arrangement due to the aggregation of dirt in the coupling arrangement or due to icing. The result of such buckling may even be kinking of the cable strand. In the end because of the deformation of the cable strand the function of the bowden cable and of the motor vehicle door lock arrangement altogether is impaired.

### SUMMARY

It is therefore the object of the invention to improve the component of a motor vehicle door lock arrangement in question such that the functional reliability is increased with low costs.

The above noted object is solved for a component as described herein.

First of all it is to be noted that the proposed component comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement. The moveable element comprises a coupling arrangement for coupling the moveable element to the first end section of the inner cable arrangement.

Various embodiments are based on the general idea to provide a support spring arrangement, which with its spring bias may act laterally with respect to the longitudinal extension of the inner cable arrangement onto the first end section of the inner cable arrangement to counteract a lateral deviation from a predefined placement of the first section.

The longitudinal extension of the inner cable arrangement is defined by the longitudinal extension of the cable strand of the inner cable arrangement. The wording “predefined placement” means the placement of the first end section of the inner cable arrangement, which corresponds to the proper function of the proposed component. This placement of the first end section may be different for different states of the proposed component. In case of the proposed component being a door handle the placement may be different in the actuated stated and the non-actuated state of the door handle.

It may be pointed out that the support spring arrangement constantly acts onto the first end section of the inner cable arrangement. However, in an embodiment, the support spring arrangement only acts onto the first end section of the inner cable arrangement if a lateral deviation from the predefined placement of the first end section actually occurs. It may also be advantageous that the support spring arrangement constantly acts on one portion of the first end section and that the support spring arrangement acts on another portion of the first end section of the inner cable arrangement only if needed due to the occurrence of a deviation from a predefined placement of the first end section. This will become apparent from the following description.

In an embodiment, the proposed component can be provided with a bowden cable with an inner cable arrangement, which first end section comprises an engagement element besides the cable strand. The engagement element further can be of the shape of a barrel, a ball, a plate or the like. This is particularly advantageous as the support spring arrangement may act onto the engagement element on the one side and on the cable strand on the other side. With the support spring arrangement acting on either or both of engagement element and cable strand it is possible with the proposed solution to exactly focus the support spring arrangement on certain goals. Such goals are, as noted above, a secure form fit reception of the engagement element in the coupling arrangement, counteracting the generation of rattling noises during drive operation of the motor vehicle, counteracting the generation of buckling of the cable strand or the like.

As noted above, the support spring arrangement may constantly act onto the first end section of the inner cable arrangement or may only act onto the first end section of the inner cable arrangement when needed due to above noted deviation from a predefined placement of the first end section. The latter can be for the cable strand, such that a force fit engagement between the spring arrangement and the cable strand is only taking place when buckling of the cable strand occurs. With this it is possible to guarantee just a minimum friction between the support spring arrangement and the cable strand, which friction would lead to undesirable high operating forces as well as to increased wear.

A very compact and low weight arrangement may be achieved with an embodiment as described herein. Here the moveable element of the proposed component comprises a return spring arrangement, which at the same time provides the support spring arrangement. This is advantageously done by making both spring arrangements of one and the same spring wire.

It has been noted above that the proposed component may be any component of the motor vehicle door lock arrangement which shall be coupled to a bowden cable.

In an embodiment, the proposed component is a door handle as noted above. In such door handles a return spring arrangement is always present, which return spring arrangement may at the same time provide the support spring arrangement as explained above.

In an embodiment, the proposed component is a motor vehicle door lock, which operating lever may be considered an above noted moveable element. The operating lever of today's motor vehicle locks are in many cases outside the housing of the motor vehicle lock, such that the proposed spring arrangement may well be applied to such motor vehicle door lock, even as a retrofit solution for existing motor vehicle door locks.

In an embodiment, the proposed component is an auxiliary closing drive, which moves the motor vehicle door from a preliminary closed position into a fully closed position. For this, the auxiliary closing drive may transmit a drive motion to a motor vehicle door lock via a bowden cable, in order to move a catch of a motor vehicle door lock from a preliminary lock position into a full lock position. Here an exact geometry of the bowden cable, in particular an exact geometry of the cable strand of the bowden cable, is of importance for the proper functioning of the auxiliary closing drive. This means that especially the above noted buckling of the cable strand is not tolerable. So far the proposed solution may be advantageously applied to such auxiliary closing drive.

Various embodiments are directed to a motor vehicle door lock arrangement with a motor vehicle door lock and a door handle.

According to the second teaching, at least one of the motor vehicle door lock and the door handle is realized as a proposed component according to the first teaching. Reference is therefore made to the explanations given for the first teaching.

In an embodiment, a component of a motor vehicle door lock arrangement is provided. The component comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement, wherein a support spring arrangement with its spring bias may act laterally with respect to the longitudinal extension of the inner cable arrangement onto the first end section of the inner cable arrangement to counteract a lateral deviation from a predefined placement of the first end section.

In an embodiment, the inner cable arrangement at its first end section comprises an engagement element, which is connected to the cable strand and that the coupling arrangement comprises a form fit reception for the engagement element in order to provide the coupling between the moveable element and the inner cable arrangement of the bowden cable, such that the engagement element is of the shape of a barrel, a ball, a plate, or the like.

In an embodiment, the support spring arrangement may act onto the engagement element to counteract a lateral deviation from a predefined placement of the engagement element, in particular to counteract the generation of rattling during driving operation of the motor vehicle.

In an embodiment, the support spring arrangement may act onto the cable strand of the first end section to counteract a lateral deviation from a predefined placement of the cable strand of the first end section, in particular to counteract the generation of buckling of the cable strand.

In an embodiment, the support spring arrangement may act onto the cable strand of the first end section in an area where the cable strand of the first end section enters into the coupling arrangement.

In an embodiment, the support spring arrangement may act onto the cable strand of the first end section in an area where the cable strand of the first end section is unguided.

In an embodiment, the first end section of the inner cable arrangement is free of the outer conduit arrangement and that the support spring arrangement may act onto the cable strand of the first end section between the coupling arrangement and the location at which the inner cable arrangement exits the outer conduit arrangement.

In an embodiment, the support spring arrangement is in constant force fit engagement with the first end section to counteract a deviation from the predefined placement of the first end section.

In an embodiment, the support spring arrangement is in constant force fit engagement with the engagement element to counteract a deviation from the predefined placement of the engagement element, in particular to counteract the generation of rattling during driving operation of the motor vehicle.

In an embodiment, the support spring arrangement is in constant force fit engagement with the cable strand of the first end section to counteract a lateral deviation from the predefined placement of the cable strand of the first end section, in particular to counteract the generation of buckling of the cable strand.

In an embodiment, the support spring arrangement is in force fit engagement with the cable strand of the first end section only during lateral deviation from the predefined placement of the cable strand of the first end section and is free of the cable strand during predefined placement of the cable strand.

In an embodiment, the support spring arrangement comprises at least one spring leg, that may act onto the first end section, such that the support spring arrangement comprises two spring legs, one of which spring legs may act onto the engagement element and the other of which spring legs may act onto the cable strand of the first end section, further, such that the two spring legs are connected to each other to form a U-shape.

In an embodiment, the support spring arrangement is coupled to the moveable element such that the support spring arrangement at least partly follows the movement of the moveable element.

In an embodiment, the support spring arrangement is at least partly made from spring wire.

In an embodiment, the moveable element comprises a return spring arrangement and that the support spring arrangement is a one piece component with the return spring arrangement, such that the return spring arrangement is made of spring wire and that the support spring arrangement is an extension of the spring wire of the return spring arrangement.

In an embodiment, the support spring arrangement may be deflected into an assembly position, in which assembly position the first end section may be brought into coupling engagement with the moveable element via the coupling arrangement without being hindered by the support spring arrangement, such that the support spring arrangement comprises an actuating part which manual actuation leads to the support spring arrangement entering the assembly position, further, such that the actuating part is realized as a loop of spring wire.

In an embodiment, the component is a door handle, wherein the door handle comprises a moveable handle bar, which is the moveable element or is coupled to the moveable element, such that the moveable element comprises a counterbalance weight element that counteracts an operation of the handle bar which is induced by crash acceleration.

In an embodiment, the component is a motor vehicle door lock, wherein the motor vehicle door lock comprises an operating lever, which is the moveable element or is coupled to the moveable element.

In an embodiment, the component is an auxiliary closing drive, wherein the auxiliary closing drive comprises a drive output element, which is the moveable element or is coupled to the moveable element.

In an embodiment, a motor vehicle door lock arrangement with a motor vehicle door lock and a door handle is provided. In an embodiment, at least one of the motor vehicle door lock and the door handle comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement, wherein a support spring arrangement with its spring bias may act laterally with respect to the longitudinal extension of the inner cable arrangement onto the first end section of the inner cable arrangement to counteract a lateral deviation from a predefined placement of the first end section.

### BRIEF DESCRIPTION OF THE FIGURES

In the following the invention will be described in an example referring to the drawings. In the drawings show

FIG. 1 a proposed motor vehicle door lock arrangement with a proposed component in the form of a door handle,

FIG. 2 the back side of the door handle according to FIG. 1 in the non-actuated state.

### DETAILED DESCRIPTION

The proposed component 1 in the drawings is realized as an outer door handle 5a, which is part of a motor vehicle door lock arrangement 2. The proposed component 1 may be any other component of the motor vehicle door lock arrangement 2, as noted above. In the following the proposed component 1 is explained with reference to the drawings as being an outer door handle 5a. All explanations given are fully applicable to different realizations of the proposed component 1.

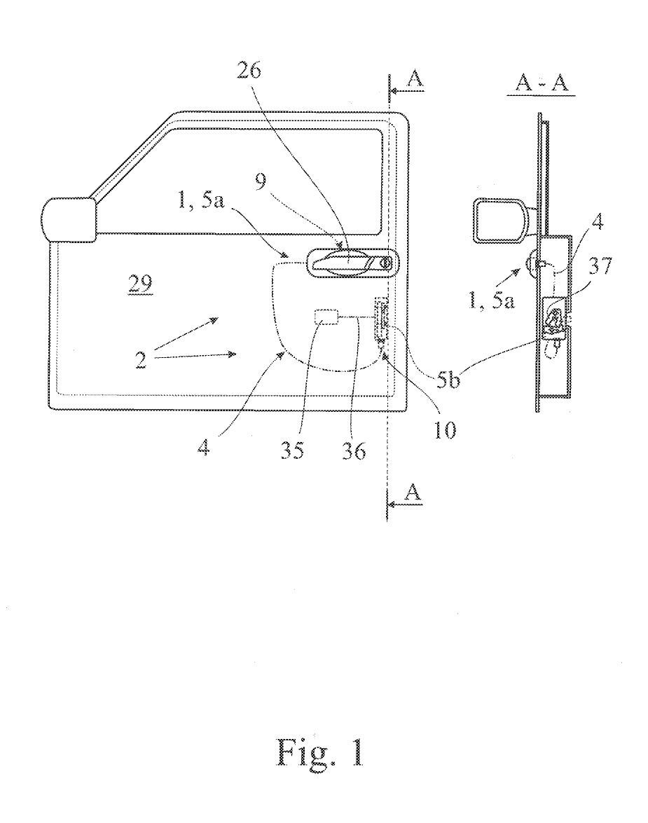

The proposed component 1 comprises a moveable element 3 which may be coupled to a bowden cable 4 as in principle is shown in FIG. 1. With the realization of the proposed component 1 as an outer door handle 5a an operation of the outer door handle 5a leads to a movement of the moveable element 3, which movement is being transferred via the bowden cable 4 to the motor vehicle door lock 5b. Depending from the locking state of the motor vehicle door lock 5b such operation of the outer door handle 5a leads to opening of the motor vehicle door lock 5b and thereby the motor vehicle door.

The focus of the present invention is the coupling of the bowden cable 4 to the proposed component 1. The bowden cable 4 comprises an inner cable arrangement 6, which is guided in an outer conduit arrangement 7, as is principally known for bowden cables 4. The inner cable arrangement 6 comprises a cable strand 8 longitudinally extending between a first end section 9 and a second end section 10 of the inner cable arrangement 6. The outer conduit arrangement 7 is fixed at a carrier section 7a.

The moveable element 3 comprises a coupling arrangement 11 for coupling the moveable element 3 to the first end section 9 of the inner cable arrangement 6.

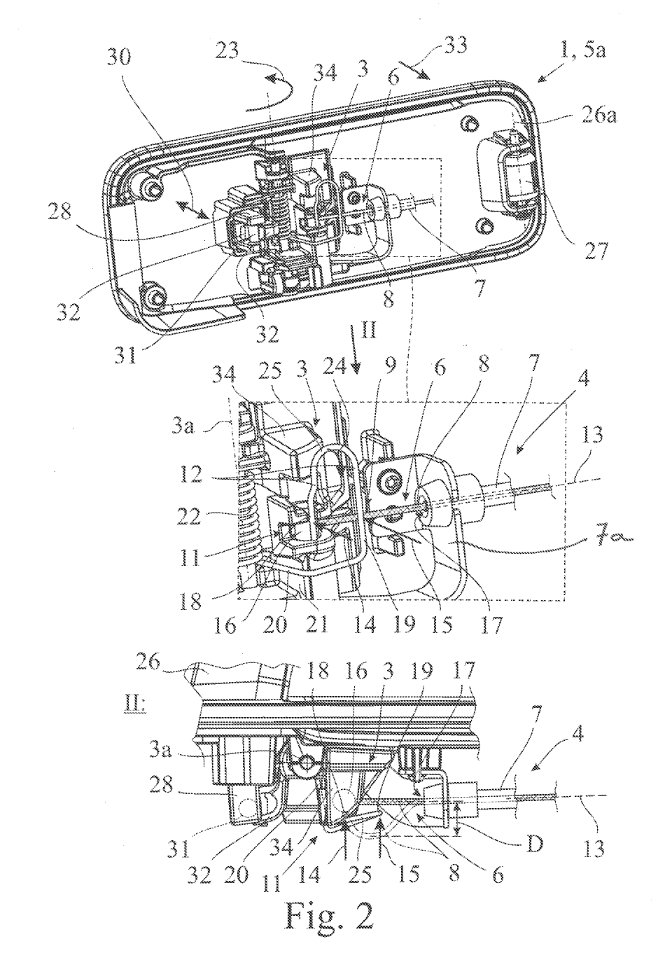

FIG. 2 shows that a support spring arrangement 12 is provided which with its spring bias may act laterally with respect to the longitudinal extension 13 of the inner cable arrangement 6 onto the first end section 9 to counteract a lateral deviation D from a predefined placement of the first end section 9. The direction of the forces acting onto the first end section 9 is indicated in FIG. 2 with reference numbers 14, 15. This will be explained in further detail later.

It is to be understood that the wording “laterally” is to be understood with respect to the longitudinal extension 13 of the inner cable arrangement 6 which is defined by the longitudinal extension of the cable strand 8.

It may be seen in FIG. 2 that the support spring arrangement 12 is in a constant force fit engagement only with part of the first end section 9 of the inner cable arrangement 6, as will be explained later as well.

For further clarification it is also to be pointed out that in FIG. 2 a possible deviation D of the cable strand 8 of the first end section 9 is indicated in dotted lines for the theoretical case that the support spring arrangement 12 was not existing. Such deviation D is being counteracted by the support spring arrangement 12 according to the invention.

The structure of the first end section 9 of the inner cable arrangement 6 becomes clear from FIG. 2. The inner cable arrangement 6 at its first end section 9 comprises an engagement element 16 which is connected to the cable strand 8. The coupling arrangement 11 comprises a form fit reception for the engagement element 16 in order to provide the coupling between the moveable element 3 and the inner cable arrangement 6 of the bowden cable 4. Here the engagement element 16 is of the shape of a barrel. Other shapes of the engagement element 16 are the shape of a ball, the shape of a plate or the like.

As noted above the support spring arrangement 12 may act onto the engagement element 16 to counteract a lateral deviation D from a predefined placement of the engagement element 16. The predefined placement of the engagement element 16 is shown in FIG. 2. The lateral deviation D can here be a slight lateral movement of the engagement element 16 within the coupling arrangement 11. Such movability of the engagement element 16 can lead to the generation of rattling during driving operation of the motor vehicle, such that the support spring arrangement 12 is specifically designed to counteract such generation of rattling during driving operation of the motor vehicle.

As an alternative or, here in addition the support spring arrangement 12 may act onto the cable strand 8 of the first end section 9 in order to counteract above noted lateral deviation D from a predefined placement of the cable strand 8 of the first end section 9. Such deviation D is indicated by the dotted lines in view II of FIG. 2, which is also called “buckling” of the cable strand 8. Such buckling of the cable strand 8 is to be counteracted by the support spring arrangement 12.

FIG. 2 shows that the support spring arrangement 12 may act onto the cable strand 8 of the first end section 9 in an area where the cable strand 8 of the first end section 9 enters into the coupling arrangement 11. This is technically appropriate as the cause of buckling of the cable strand 8 goes back to the situation inside the coupling arrangement 11 as noted above.

From FIG. 2 it also is apparent that the support spring arrangement 12 may act onto the cable strand 8 of the first end section 9 in an area where the cable strand 8 of the first end section 9 is unguided. For one thing this means that the first end section 9 is free of the outer conduit arrangement 7. It also means that guiding means other than the support spring arrangement 12 are not existent in this particular area. As a result the cable strand 8 in this particular area is very susceptible to buckling, such that the support spring arrangement 12 acting onto the cable strand 8 of the first end section 9 in this particular area is especially advantageous.

As noted above the first end section 9 of the inner cable arrangement 6 is free of the conduit arrangement 7, wherein the support spring arrangement 12 may act onto the cable strand 8 of the first end section 9 between the coupling arrangement 11 and the location 17 at which the inner cable arrangement 6 exits the conduit arrangement 7.

In the shown embodiment the support spring arrangement 12 is in constant force fit engagement with the first end section 9 of the inner cable arrangement 6 to counteract a deviation D from the predefined placement of the first end section. This is realized for the engagement element 16, as the support spring arrangement 12 is in constant force fit engagement with the engagement element 16 to counteract a deviation from the predefined placement of the engagement element 16 and in particular to counteract the generation of above noted rattling during driving operation of the motor vehicle.

It may also be advantageous that the support spring arrangement 12 is in constant force fit engagement with the cable strand 8 of the first end section 9 to counteract a lateral deviation D from the predefined placement of the cable strand 8 of the first end section 9, in particular to constantly counteract the generation of buckling of the cable strand 8. With this, however, one has to take into account the constant generation of additional friction between the support spring arrangement 12 and the cable strand 8. Because of this, in the shown embodiment, it is proposed that the support spring arrangement 12 is in force fit engagement with the cable strand 8 of the first end section 9 only during lateral deviation D from the predefined placement of the cable strand 8 of the first end section 9 (shown in FIG. 2 in dotted lines) and is free of the cable strand 8 during predefined placement of the cable strand 8 (shown in FIG. 2 in solid lines).

The same concept may be applied to the engagement element 16. Then it is proposed that the support spring arrangement 12 is in force fit engagement with the engagement element 16 only during lateral deviation from the predefined placement of the engagement element 16 and is free of the engagement element 16 during predefined placement of the engagement element (shown in FIG. 2).

The constructional realization of the shown support spring arrangement 12 is compact and cost effective. The support spring arrangement 12 comprises at least one spring leg, here two spring legs 18, 19, which spring legs are into engagement or may come into engagement with the first end section 9. Here the support spring arrangement 12 comprises two spring legs 18, 19, one 18 of which spring legs 18, 19 acts onto the engagement element 16 and the other 19 of which spring legs 18, 19 acts onto the cable strand 8 of the first end section 9. For easy manufacturing those two spring legs 18, 19 are connected to each other to form a U-shape. In particular, the U-shape is provided by a one-piece component.

The moveable element 3 here may perform a pivot movement around a geometrical pivot axis 3a. The engagement element 16 and with it the first end section 9 of the inner cable arrangement 6 follow this movement. In order to prevent undesired additional friction between the support spring arrangement 12 and the moveable element 3, here the support spring arrangement 12 is coupled to the moveable element 3 such that the support spring arrangement 12 at least partly follows the movement of the moveable element 3. This is realized in the shown embodiment by one leg 20 of the support spring arrangement 12 resting on a shoulder 21 of the moveable element 3. Here the spring bias of the support spring arrangement 12 is such that the leg 20 is spring-biased onto the shoulder 21, such that the support spring arrangement 12 is forced to follow the movement of the moveable element 3.

An especially cost effective manufacturing process for the support spring arrangement 12 may be realized by making the support spring arrangement 12 at least partly from spring wire as shown in FIG. 2, which can be metal wire. Alternatively it is possible that the support spring arrangement 12 is at least partly made from, elastic, plastic material.

As shown in FIG. 2 the moveable element 3 comprises a return spring arrangement 22, which urges the moveable element 3 into the return direction indicated with reference number 23. In order to guarantee a compact and cost effective arrangement it is proposed that the return spring arrangement 22 and the support spring arrangement 12 are designed as a one-piece component. It may be seen from FIG. 2 that the return spring arrangement 22 is an extension of the spring wire of the return spring arrangement 22. Here the return spring arrangement 22 is a coil spring arrangement which in the mounted state is aligned to the pivot axis 3a of the moveable element 3.

The above noted U-shape of part of the support spring arrangement 12 has another advantage in view of the assembly of the first end section 9 of the inner cable arrangement 6. The support spring arrangement 12 may be deflected into an assembly position, in which assembly position the first end section 9 may be brought into coupling engagement with the moveable element 3 via the coupling arrangement 11 without being hindered by the support spring arrangement 12. This deflection is indicated in FIG. 2 with reference number 24. For an easy deflection the support spring arrangement 12 comprises an actuating part 25 which manual actuation in the direction 24 leads to the support spring arrangement 12 entering the assembly position. In various embodiments, the actuating part 25 is realized as a loop of spring wire. Here the actuating part 25 is the bottom of the above noted U-shaped part of the support spring arrangement 12. This particular construction even allows a one hand installation of the first end section 9 of the inner cable arrangement 6.

As noted above the proposed component 1 can be any component of the motor vehicle door lock arrangement 2, which is coupled to a bowden cable 4. Here the component 1 is a door handle 5a, which according to FIG. 1 is an outer door handle 5a. Generally the proposed component 1 may be an inner door handle 5a as well. The door handle 5a comprises a moveable handle bar 26, which front side is shown in FIG. 1. The handle bar 26 comprises two end portions 27, 28, which extend through the outer door skin 29 onto the back side of the door handle 5a, which back side is shown in FIG. 2. Here it becomes clear that the handle bar 26 at its end portion 27 may be pivoted around pivot axis 26a which leads to the end portion 28 to make a nearly linear movement 30 as noted in FIG. 2 as well. The end portion 28 of the handle bar 26 comprises a bolt 31, which is received by a mouth shaped portion 32 of the moveable element 3 such that pulling the handle bar 26 leads to a movement of the end portion 28 pulling the mouth shaped portion 32 of the moveable element 3 to the outside of the door, pivoting the moveable element 3 against the spring tension of the return spring arrangement 22. This again leads to the engagement element 16 and with it the cable strand 8 to be pulled to the left in FIG. 2 which, depending on the lock state of the motor vehicle door lock 5b, may open the motor vehicle door lock 5b.

The embodiment shown in FIG. 2 shows a moveable element 3 of special structure. In further detail the moveable element 3 comprises a counter balance weight element 34 that counteracts an operation of the handle bar 26 which is induced by crash acceleration 33. An crash acceleration in this sense is an acceleration that goes back on a side impact on the side door shown in FIG. 1, which due to inertia characteristics of the handle bar 26 leads to operating the handle bar 26 relative to the rest of the door handle 5a. In order to prevent such unintended operation of the handle bar 26 the counterbalance weight element 34 of the moveable element 3 is laid out and distributed with respect to the pivot axis 3a such that the inertia characteristics of the moveable element 3 overbalances the inertia characteristics of the handle bar 26 correspondingly. Here the coupling arrangement 11 and the support spring arrangement 12 are both arranged in or at the counterbalance weight element 34. This is advantageous as the counterbalance weight element 34 due to its necessary weight reserves a considerable amount of installation space which can be used in a second function for the coupling arrangement 11 on the one hand and for the support spring arrangement 12 on the other hand.

Also the proposed component 1 may as well be a motor vehicle door lock 5b, which comprises an operating lever, which is the moveable element or is coupled to the moveable element in the above noted sense. Such operating lever is not displayed in the drawings.

Furthermore it is possible that the proposed component 1 is an auxiliary closing drive 35, which is coupled to the motor vehicle door lock 5b by another bowden cable 36. The auxiliary closing drive 35 may, for example, serve to move a catch 37 of the motor vehicle door lock 5b from a preliminary lock position into a main lock position in order to move the motor vehicle door into a fully closed position as noted above. For this the auxiliary closing drive 35 comprises a drive output element, which is the moveable element 3 or is coupled to the moveable element 3 in the above noted sense. A drive output element of the auxiliary closing drive 35 is not shown in the drawings as well.

Also described herein is a motor vehicle door lock arrangement 2, which at least comprises a motor vehicle door lock 5b and a door handle 5a. It is proposed that at least one of the motor vehicle door lock 5b and the door handle 5a is realized as a proposed component 1 explained above. In further detail at least one of the motor vehicle door lock 5b and the door handle 5a comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement, wherein a support spring arrangement with its spring bias may act laterally with respect to the longitudinal extension of the inner cable arrangement onto the first end section to counteract a lateral deviation from a predefined placement of the first end section. Reference is made to all explanations given with respect to the first teaching.

1. A component of a motor vehicle door lock arrangement, wherein the component comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement,
wherein a support spring arrangement with its spring bias may act laterally with respect to the longitudinal extension of the inner cable arrangement onto the first end section of the inner cable arrangement to counteract a lateral deviation from a predefined placement of the first end section.

2. The component according to claim 1, wherein the inner cable arrangement at its first end section comprises an engagement element, which is connected to the cable strand and that the coupling arrangement comprises a form fit reception for the engagement element in order to provide the coupling between the moveable element and the inner cable arrangement of the bowden cable.

3. The component according to claim 1, wherein the support spring arrangement may act onto the engagement element to counteract a lateral deviation from a predefined placement of the engagement element.

4. The component according to claim 1, wherein the support spring arrangement may act onto the cable strand of the first end section to counteract a lateral deviation from a predefined placement of the cable strand of the first end section.

5. The component according to claim 1, wherein the support spring arrangement may act onto the cable strand of the first end section in an area where the cable strand of the first end section enters into the coupling arrangement.

6. The component according to claim 1, wherein the support spring arrangement may act onto the cable strand of the first end section in an area where the cable strand of the first end section is unguided.

7. The component according to claim 1, wherein the first end section of the inner cable arrangement is free of the outer conduit arrangement and that the support spring arrangement may act onto the cable strand of the first end section between the coupling arrangement and the location at which the inner cable arrangement exits the outer conduit arrangement.

8. The component according to claim 1, wherein the support spring arrangement is in constant force fit engagement with the first end section to counteract a deviation from the predefined placement of the first end section.

9. The component according to claim 1, wherein the support spring arrangement is in constant force fit engagement with the engagement element to counteract a deviation from the predefined placement of the engagement element.

10. The component according to claim 1, wherein the support spring arrangement is in constant force fit engagement with the cable strand of the first end section to counteract a lateral deviation from the predefined placement of the cable strand of the first end section.

11. The component according to claim 1, wherein the support spring arrangement is in force fit engagement with the cable strand of the first end section only during lateral deviation from the predefined placement of the cable strand of the first end section and is free of the cable strand during predefined placement of the cable strand.

12. The component according to claim 1, wherein the support spring arrangement comprises at least one spring leg, that may act onto the first end section.

13. The component according to claim 1, wherein the support spring arrangement is coupled to the moveable element such that the support spring arrangement at least partly follows the movement of the moveable element.

14. The component according to claim 1, wherein the support spring arrangement is at least partly made from spring wire.

15. The component according to claim 1, wherein the moveable element comprises a return spring arrangement and that the support spring arrangement is a one piece component with the return spring arrangement.

16. The component according to claim 1, wherein the support spring arrangement may be deflected into an assembly position, in which assembly position the first end section may be brought into coupling engagement with the moveable element via the coupling arrangement without being hindered by the support spring arrangement.

17. The component according to claim 1, wherein the component is a door handle, wherein the door handle comprises a moveable handle bar, which is the moveable element or is coupled to the moveable element.

18. The component according to claim 1, wherein the component is a motor vehicle door lock, wherein the motor vehicle door lock comprises an operating lever, which is the moveable element or is coupled to the moveable element.

19. The component according to claim 1, wherein the component is an auxiliary closing drive, wherein the auxiliary closing drive comprises a drive output element, which is the moveable element or is coupled to the moveable element.

20. A motor vehicle door lock arrangement with a motor vehicle door lock and a door handle, wherein at least one of the motor vehicle door lock and the door handle comprises a moveable element which may be coupled to a bowden cable, which bowden cable comprises an inner cable arrangement, which is guided in an outer conduit arrangement, which inner cable arrangement comprises a cable strand longitudinally extending between a first end section and a second end section of the inner cable arrangement, wherein the moveable element comprises a coupling arrangement for coupling the moveable element to the first end section of the inner cable arrangement,
wherein a support spring arrangement with its spring bias may act laterally with respect to the longitudinal extension of the inner cable arrangement onto the first end section of the inner cable arrangement to counteract a lateral deviation from a predefined placement of the first end section.
